(19) United States
(12) Patent Application Publication
(10) Pub. No.: US 2009/0234581 A1
(43) Pub. Date: Sep. 17, 2009

(54) DEVICE FOR PROCESSING NAVIGATION DATA OF A SATELLITE NAVIGATION SYSTEM FOR DELIVERING INTEGRITY AREA MAPS

(75) Inventors: Jean Christophe Levy, Balma (FR); Didier Flament, Quint-Fonsegrives (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/092,858

(22) PCT Filed: Nov. 6, 2006
(86) PCT No.: PCT/FR2006/051139

§ 371 Date: Nov. 21, 2008

(30) Foreign Application Priority Data
Nov. 7, 2005 (EP) 05300896.7

(51) Int. Cl. G01C 21/00

(52) U.S. Cl. 701/214

(57) ABSTRACT

A device (PD) is dedicated to processing navigation data related to satellites in a satellite navigation system in orbit around a heavenly body. This device (PD) comprises processing means (PM) tasked with comparing integrity data (ID), which represents reliability values of corrections to errors in the orbital positioning and/or synchronization of the satellites, to at least one selected set of N selected threshold values, N being an integer greater than or equal to one, in such a way as to deliver at least one group of cartographic data representative of at most N+1 geographic areas defined with respect to said heavenly body and in which said integrity data is less than the N threshold values of the selected set, greater than the N threshold values of the selected set Si, or between two threshold values of the selected set.

The invention pertains to satellite navigation systems, and more precisely to integrity information that represents reliability values of corrections to errors in the orbital positioning and/or synchronization of the satellites of such systems.

Here, the term “satellite navigation system” refers to any system dedicated to wide-area navigation, such as the existing systems known as GPS, EGNOS, and WAAS, or the future GALILEO system, as well as all their equivalents and derivatives.

As is known to a person skilled in the art, navigation messages, which are sent to the terminals of users by satellites of the satellite navigation systems, include navigation information related to their orbital position and/or their synchronization (a difference between their internal clock and the system's master clock). This navigation information is determined in three steps. The first step consists of selecting raw information. As this information is marred by errors, the error corrections that must be applied to it are determined in a second step. The third step consists of error-correcting the raw information, so that it becomes navigation information.

Because of how critical the navigation information may be for some users, such as airplane pilots, integrity data that represents the reliability values of the error corrections used to produce said information are also selected. This integrity data is transmitted to users, so that they can act accordingly.

For example, in an EGNOS system, two pieces of integrity data are selected: one is called UDRE (for “User Differential Range Error”) and is associated with the satellite, while the other is called GIVE (for “Grid Ionospheric Vertical Error”) and is associated with the ionosphere.

When drawing a graph showing the change in number of users of a satellite navigation system as a function of orbital and synchronization positioning errors, the result is a roughly plane-shaped line, one of the corners of which corresponds to the user (the so-called “worst user”) who, due to his position, has access to the least reliable navigation information. By definition, the UDRE is the value of the orbital positioning and synchronization error which has a fixed probability of increasing the orbital positioning and synchronization error of the worst user. It therefore constitutes a reference value that is a function of the worst user's integrity margin All users, other than the worst user, therefore have an integrity margin (defined with respect to the UDRE) greater than the integrity margin of said worst user.

To calculate the integrity data, a tool is used, such as the one known as SREW (for “Satellite Residual Error for the Worst user”).

As is known to a person skilled in the art, the integrity data is not fixed. It changes over time, particularly depending on the status of the satellite navigation system's architecture. For this reason, whenever information is lost in the system, or whenever a satellite navigation system device located in the vicinity of the worst user, such as a monitoring station tasked with collecting navigation messages transmitted by satellites as well as with taking measurements related to the estimated distances that separate them from visible satellites, breaks down or is undergoing maintenance, the calculation center is missing information, so that the UDRE is no longer located at a fixed distance (as a function of the probability of an increase) from the value of the orbital positioning and synchronization error of the worst user. In other terms, the integrity margin of the worst user is reduced.

Today, whenever such a situation arises, the team tasked with monitoring the satellite navigation system's functioning interrupts the providing of navigation messages to users, in order to maintain physical integrity. However, this interruption, which is completely justified for some of the users, penalizes the majority of other users whose initial integrity margin was considerably greater than the initial margin of integrity of the worst user, and who could have continued to use the satellite navigation system without any real increase in danger.

The purpose of the invention is therefore to improve the situation.

To that end, it discloses a device for processing navigation data related to satellites in a satellite navigation system, orbiting around a heavenly body, comprising processing means tasked with comparing integrity data that represents reliability values for error corrections in satellite positioning and/or synchronization, to at least one selected set of N selected threshold values, N being an integer greater than or equal to one, in such a way as to deliver at least one group of cartographic data that represents at most N+1 geographic areas defined with respect to the heavenly body and in which the integrity data is less than N threshold values of the selected set, greater than N threshold values of the selected set, or between two threshold values of the selected set.

The device of the invention may include other characteristics that may be taken separately or in combination, in particular:
its processing means may be tasked with comparing integrity data to at least two selected sets of Ni selected threshold values, Ni being integers greater than or equal to one, in order to deliver at least two groups of cartographic data that each represent at most Ni+1 geographic areas defined with respect to the heavenly body, and in which this integrity data is less than Ni threshold values of the selected set, greater than Ni threshold values of the selected set, or between two threshold values of the selected set;
the threshold values may, for example, represent integrity margins with respect to a master value (such as UDRE), itself defined with respect to the user of the satellite navigation system having the worst reliability value of error corrections in positioning and/or synchronizing satellites;
its processing means may be tasked with determining each group of cartographic data based on the most recent integrity data, in order to enable nearly real-time functioning;
it may comprise calculation means tasked with determining integrity data based at least on, firstly, first data representing information contained within navigation messages distributed by satellites; secondly, second data representing satellite position estimates; and thirdly, third data representing estimates of time differences in the clocks of satellites with respect to a master clock;
   the calculation means may then be tasked with determining integrity data based on first, second, and third reference data and fourth data representing a selected architecture for a satellite navigation system. This enables a predictive functioning of the satellite navigation system and/or determining the influence of breakdowns and/or maintenance activity on devices of the satellite navigation system;
   the processing means may potentially be incorporated within the calculation means;
it may comprise display means tasked with drawing the geographic areas, defined by the determined cartographic data, with respect to corresponding regions on the surface of the heavenly body.

The invention is particularly well-suited, though non-exclusively, to the integrity services of satellite navigation systems, such as GALILEO, GPS, EGNOS, and WAAS, as well as their variants and equivalents.

Other characteristics and advantages of the invention will become apparent upon examining the detailed description below, and the attached drawings, in which:

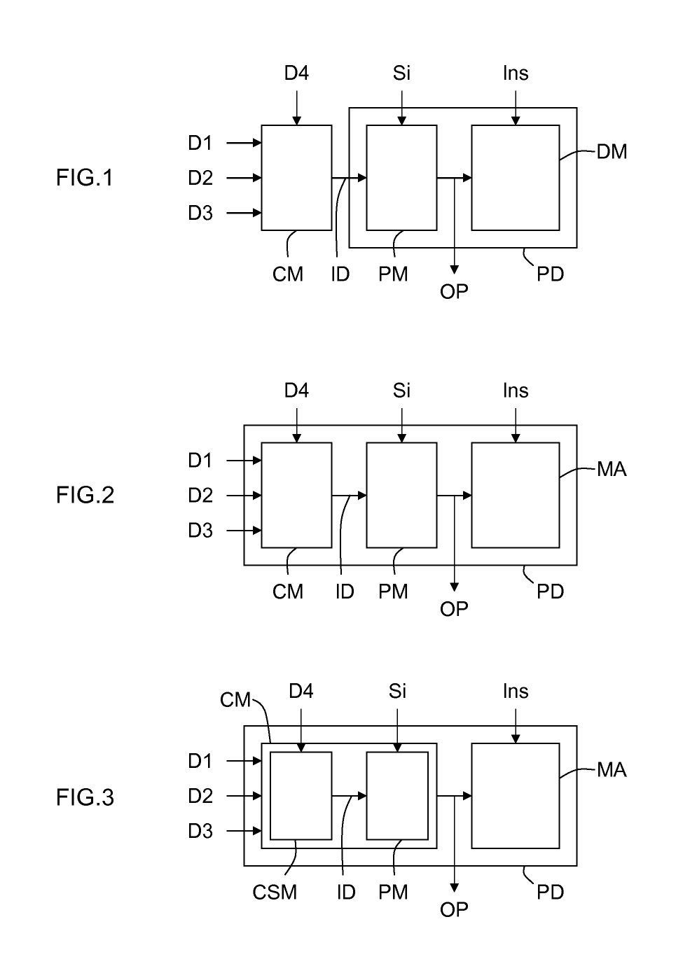

FIG. 1 schematically and functionally depicts a first example embodiment of a processing device of the invention, coupled to a tool for calculating integrity data,

FIG. 2 schematically and functionally depicts a second example embodiment of a processing device of the invention, incorporated means for calculating integrity data,

FIG. 3 schematically and functionally depicts a variant of the second example embodiment of the processing device depicted in FIG. 2,

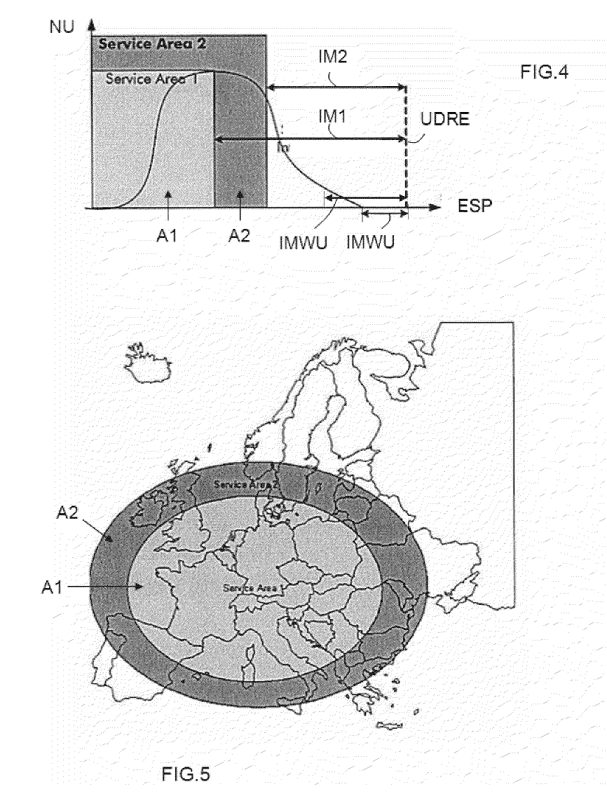

FIG. 4 is a diagram depicting the graph of the change in the number (NU) of users of a satellite navigation system as a function of errors in orbital positioning and/or synchronization (ESP) and the drawing of the two (service) areas defined using a processing device of the invention and whose integrity data values are, respectively, greater and less than a selected threshold value, and

FIG. 5 schematically depicts the positions of the two (service) areas of FIG. 4 with respect to a partial map of Europe.

The attached drawings may serve not only to complete the invention, but may also contribute to defining it, if need be.

The purpose of the invention is to enable flexibility in using integrity data and/or the determination of the influence of breakdowns and/or maintenance activity on the integrity data of a geographic area in devices of the satellite navigation system.

In what follows, it is assumed, by way of a non-limiting example, that the satellite navigation system is the “augmented” (or SBAS for “Satellite-Based Augmentation System”) EGNOS system. However, the invention is not limited to SBAS satellite navigation systems. It pertains generally to any system dedicated to satellite navigation in wide areas (or regions), such as existing GPS (in particular GPS III) and WAAS systems, or the future GALILEO system, as well as all their equivalents and derivatives.

As is known to a person skilled in the art, a satellite navigation system comprises a constellation of satellites, a set of monitoring stations (terrestrial or in space), and a calculation center.

Schematically, the constellation's satellites are in orbit around a heavenly body, such as the Earth, and are, in particular, tasked with emitting signals making it possible to measure estimated distances, and to broadcast to the Earth E navigation messages which are transmitted to them by the mission ground segment, so that the information that they contain can be used by users' navigation receivers and by the monitoring stations.

The monitoring stations are located in selected places on the Earth or in spacecraft, such as satellites. They are, in particular, tasked firstly with collecting navigation messages transmitted by the constellation's satellites, and secondly, with taking measurements related to the estimated distances that separate them from visible satellites in order to communicate them to the calculation center.

The calculation center is generally installed on the Earth. It generally comprises a consistency checking device that, in particular, is tasked with checking for consistency between the estimated distances and the information contained within the navigation messages (broadcast by the satellites), which are communicated to it by the monitoring stations. The calculation center may also be tasked with predicting the trajectories of the satellites and the differences between their internal clocks and a system master clock, based on the estimated distances determined by the monitoring stations.

These trajectory predictions and time differences (synchronization) are used to generate future navigation messages, which are transmitted to the satellites so that they can broadcast them. They incorporate the error corrections found in the introduction. Furthermore, they are completed by the integrity data that represent reliability values for the error corrections, and which are transmitted to the users, so that they can act accordingly. This integrity data may, for example, be determined using a tool such as SREW Tool.

The invention pertains more particularly to the processing of integrity data that makes up a part of the navigation data.

Firstly, FIG. 1 describes a first example embodiment of a device PD of the invention, dedicated to processing navigation data. Such a device PD may, for example, by installed in the calculation center. However, this is not mandatory.

In the invention, the processing device PD comprises at least one processing module that, in particular, is tasked with comparing integrity data ID that represents reliability values of corrections to errors in the orbital positioning and/or synchronization of the satellites in the constellation, to at least one selected set of N selected threshold values. Here, N is an integer greater than or equal to 1 (N>0).

In the example depicted in FIG. 1, the integrity data ID are provided by an external calculation tool CM, such an a SREW Tool. However, in one variant, depicted in FIG. 2, the processing device PD may either incorporate the calculation tool CM tasked with delivering integrity data ID, or be an advanced calculation tool comprising a module for calculating integrity data CM coupled to a processing module PM. In another variant depicted in FIG. 3, the processing device PD may include a calculation module CM incorporating both an integrity data calculation submodule CSM and a processing module that are coupled together.

The calculation (sub)module CM (or CSM) is tasked with determining the integrity data ID based on at least the first D1, second D2, and third D3 external data.

The first external data D1 represents information that is contained within navigation messages broadcast by the constellation's satellites. More precisely, it is error correction information coming from space, also known as “signal in space corrections”.

The second external data D2 represents estimates of satellite positions. These estimates are, more precisely, what are normally called the true positions of the satellites. They represent the satellites' most accurate orbital positions. Such external data D2 may be obtained by any means known to a person skilled in the art, and particularly over the Internet (such as from an IGS), or by way of a system capable of providing an accurate, reliable estimate of the satellites' orbits and times.

The third external data D3 represent estimates of time differences in the clocks of satellites with respect to a master clock from the satellite navigation system. These estimates are, more precisely, what are normally called the true time differences of the satellites. They represent the satellites' most accurate orbital positions. Such external data D3 may be obtained by any means known to a person skilled in the art, and particularly over the Internet (such as from an IGS), or by way of a system capable of providing an accurate, reliable estimate of the satellites' orbits and times.

The integrity data ID delivered by the calculation (sub)module C(S)M may, for example, be what is commonly called errors in the orbital positioning and/or synchronization of satellites ESP.

When these errors in the orbital positioning and/or synchronization of satellites ESP and the positions of the users' navigation receivers are known, it is then possible to know the graph of the change in the number NU of users of a satellite navigation system as a function of errors in orbital positioning and/or synchronization ESP. An example of such a graph is depicted in the diagram in FIG. 4.

Whenever, at a given moment, the calculation module CM has all information that is pertinent to its calculations, i.e. when no information—has been lost and all devices in the satellite navigation system are functioning, in particular the monitoring stations, the right end of the graph makes it possible to determine which user has the worst error value in the orbital positioning and/or synchronization ESP. This user is called “the worst user”. This worst value is used to determine the value of the UDRE (defined in the introduction). The monitoring team may decide to interrupt or authorize the use of the navigation data depending on the system's ability to calculate a reliable UDRE (for example 10⁻⁷/150 seconds) for the worst user in the area. More precisely, the UDRE is located a fixed distance away from the abovementioned worst value. This fixed distance defines what is known as the initial integrity margin of the worst user IMWU, which is the lowest of all integrity margins that the users of the satellite navigation system possess.

Whenever the information that is pertinent for calculating integrity data is missing in the area where the worst user is located, the integrity margin of the worst user IMWU′ is then reduced (IMWU′<IMWU), because the value of the UDRE is fixed by the initial value IMWU. In such a case, the graph drops as it moves right, as depicted in the example in FIG. 4. As the monitoring team is unable to tell when such a situation has arisen, it therefore assumes that a minimal configuration of the network of monitoring stations is needed to ensure this integrity margin. Thus, the decision to shut down the system is made based on criteria that have a very low correlation with the integrity margin, and is therefore adjusted conventionally.

The invention is meant to introduce flexibility into making decisions related to interrupting the providing of navigation data to users.

Indeed, as indicated above, once the processing module PM has access to integrity data ID, such as the users' integrity margins, it may compare them to one (or more) selected set(s) Si of Ni selected threshold values, with i being an integer greater than or equal to one (i>0). This comparison thereby enables the processing module PM to deliver one (or more) groups of cartographic data G1, which represent at most Ni+1 geographic areas Aj (j=1 to Ni+1) defined with respect to the heavenly body, and in which the integrity data (such as integrity margins) ID is less than Ni threshold values of the selected set Si, greater than Ni threshold values of the selected set Si, or between two threshold values of the selected set Si.

Each geographic area Aj thereby constitutes a (service) area in which the integrity margin (for example) falls within a specific range of values.

Here, the term “cartographic data” refers to data that gives a position with respect to a selected two- or three-dimensional reference point, and to an identifier representing the corresponding area Aj. This identifier may, for example, be a piece of information designating a particular color, or a particular shade of gray, or a particular texture.

In the example depicted in FIG. 4, two thresholds T1 and T2 have been used to define two areas A1 and A2. Area A1 corresponds to the integrity data (such as the integrity margins) ID, which are less than the two (N=2) threshold values of a single set (S1). Area A2 corresponds to the integrity data (such as the integrity margins) ID, which fall between the two (N=2) threshold values of the set (S1). The area A1 is therefore an area in which the integrity margin is high, while area A2 is an area in which the integrity margin is low, while still be acceptable for many users.

For example, all users located within area A1 may use the navigation data, no matter what their usage is, while only the users who are included within area A2 and who use an application that does not require maximum reliability are authorized to use navigation data. Outside of area A2, the integrity margin is considered to be too low for any usage of navigation data.

Such a situation may, for example, correspond to two types of users: those who use navigation data to fly airplanes, and for whom maximum reliability is imperative (they must be located within area A1), and those who use navigation data to steer boats, and for whom a medium level of reliability is sufficient (they must be located within area A1 or A2).

Here, the term “types of users” refers to users who use navigation data for different applications.

This situation may also correspond to a single type of users, such as those who use navigation data to fly airplanes, and for whom maximum reliability is imperative during the landing phase (they must be located within area A1), while a medium level of reliability is sufficient during the flight (they must be located within area A1 or A2 at the time).

It is important to note that the processing device PD of the invention may also be used to obtain multiple (at least two) groups G1 of cartographic data intended for different type of users Ti. For example, a group G1 of cartographic data may be determined for users who use navigation data to fly airplanes, while a group G2 of cartographic data may be determined for users who use navigation data to steer boats. In such a case, each group G1 may be determined based on a comparison made using the set Si, of Ni selected threshold values, which was defined by the monitoring team for a given type of user Ti.

The cartographic data may be delivered at an output OP so that it can be transmitted to one or more selected locations, such as an air traffic control organization, in order to inform the air traffic community, and/or to the organization that controls the satellite navigation system (such as the PACF, for EGNOS), and/or the satellites in the constellation, so that they can broadcast them to users as signals in space.

The cartographic data may also be delivered to a display module DM of the processing device PD, as is depicted in FIGS. 1 to 3, so that it can manage their drawing compared with a selected reference point, with respect to at least one selected part of the Earth, on a display monitor (not shown). An example of such a drawing is depicted in FIG. 5. In this example, the two (service) areas A1 and A2, introduced above, are drawn onto a partial map of Europe, in light and dark gray, respectively.

The display module DM may be configured in such a way as to draw geographic shapes onto the map displayed of the areas Aj, such as elliptical, circular, or ring shapes. However, this is not mandatory.

Furthermore, the display module DM may potentially include an input enabling the monitoring team to send it instructions Ins related to the display, such as to select a part of the map, or to zoom in, or to locate an airport. To that end, the processing device PD may include or be connected to a human/machine interface, which would also be used to communicate to it the definitions of the sets Si of Ni selected threshold values.

In the preceding, an application of the invention for the almost real-time processing of navigation data has been described, each group of cartographic data Gi being determined based on the most recent integrity data. However, the processing device PD of the invention may also be used for predictive studies and/or studies intended to determine the influence of breakdowns and/or maintenance activity on satellite navigation system devices, such as monitoring stations.

These studies may make it possible to simulate situations before they occur, in order to remedy or plan countermeasures for the potential nuisances that they may cause.

To do so, the calculation module C(S)M is supplied, firstly, with the first D1, second D2, and third D3 reference data intended to be representative of an example functioning of the satellite navigation system, and secondly, with the fourth data D4 that represents a selected architecture for a satellite navigation system.

Here, the term “selected architecture” refers to defining the set of devices of the satellite navigation system whose data is pertinent to the calculation module C(S)M for determining integrity data DI.

For example, the monitoring team may determine the influence on the group(s) of cartographic integrity data G1 of interrupting the operation of one or more monitoring stations due to a breakdown or maintenance activity.

The processing device PD of the invention, and particularly its processing module PM and its potential calculation module CM (or CSM) and display module DM, may be constructed in the form of electronic circuits, software (or computer) modules, or a combination of circuits and software.

The invention offers a certain number of advantages, including:
it introduces flexibility into the process of making decisions to interrupt the use of navigation data, thereby making it possible to limit the number of users penalized by an interruption, and to increase the operating performance of the satellite navigation system in certain service areas,
it makes it possible to determine the entire service area in which the navigation data are accessible to users, i.e. no matter what its integrity margin is deemed to be, and consequently, to adapt the service offering based on the determined area.

The invention is not limited to the embodiments of the processing device described above, which are only given as an example; rather, it encompasses all variants that a person skilled in the art may envision within the framework of the claims below.

1. A device (PD) for processing navigation data related to satellites in a satellite navigation system orbiting around a heavenly body, characterized in that it comprises processing means (PM) configured to compare integrity data (ID) representative of reliability values for corrections of errors in the orbital positioning and/or synchronization of said satellites, to at least one selected set of N selected threshold values, N being an integer greater than or equal to one, in such a way as to deliver at least one group of cartographic data representative of at most N+1 geographic areas defined with respect to said heavenly body and in which said integrity data is less than said N threshold values of said selected set, greater than said N threshold values of said selected set Si, or between two threshold values of said selected set.

2. A device according to claim 1, characterized in that said processing means (PM) are configured to compare integrity data (ID) to at least two selected sets (Si) of Ni selected threshold values, Ni being integers greater than or equal to one, in such a way as to deliver at least two groups (Gi) of cartographic data that each represent at most Ni+1 geographic areas (Aj) defined with respect to said heavenly body and in which said integrity data is less than said Ni threshold values of the selected set (Si), greater than said Ni threshold values of the selected set (Si), or between two threshold values of the selected set (Si).

3. A device according to claim 1, characterized in that said threshold values are representative of integrity margins with respect to a reference value, which is itself defined with respect to a user of said satellite navigation system having the worst reliability value of corrections of errors in satellite orbital positioning and/or synchronization.

4. A device according to claim 1, characterized in that said processing means (PM) are configured to determine each group of cartographic data (G1) from the most recent integrity data (ID), in such a way as to enable almost real-time functioning.

5. A device according to claim 1, characterized in that it comprises calculation means (CM; CSM) configured to determine said integrity data (ID) from at least i) first data (D1) representing information contained within navigation messages broadcast by said satellites, ii) second data (D2) representing estimated positions for said satellites, and iii) third data (D3) representing estimated time differences between the clocks of said satellites compared to a master clock.

6. A device according to claim 5, characterized in that said calculation means (CM; CSM) are configured to determine said integrity data (ID) from the first (D1), second (D2), and third (D3) reference data, and from fourth data (D4) representing a selected architecture for said satellite navigation system, in such a way as to enable a predicted functioning and/or to determine the influence of breakdowns and/or maintenance activity on devices in said satellite navigation system.

7. A device according to claim 5, characterized in that said processing means (PM) are incorporated into said calculation means (CM).

8. A device according to claim 1, characterized in that comprises display means (DM) for drawing geographic areas (Aj), defined by said determined cartographic data, with respect to corresponding regions in the surface of said heavenly body.

9. The usage of the navigation data processing device (PD) according to claim 1, for integrity services of satellite navigation systems selected from a group comprising at least GALILEO, GPS, EGNOS and WAAS, as well as their variants and equivalents.
